(19) United States
(12) Patent Application Publication
(10) Pub. No.: US 2012/0198341 A1
(43) Pub. Date: Aug. 2, 2012

(54) System and Method of Automatic Scaling of Clinical Data for Varied Display Size

(75) Inventors: Matthew R. Pekarske, Milwaukee, WI (US); Michael J. Palmer, New Berlin, WI (US); Brian Bayer, Milwaukee, WI (US); Bruce Friedman, Japser, GA (US); Antti Ylostalo, Helsinki (FI); David Meier, Milwaukee, WI (US)

(73) Assignee: GENERAL ELECTRIC COMPANY, Schenectady, NY (US)

(21) Appl. No.: 13/015,840

(22) Filed: Jan. 28, 2011

(51) Int. Cl. G06F 3/048

(52) U.S. Cl. 715/733; 715/762

(57) ABSTRACT

The system and method of the present application allows for the configurable display of a number of physiological parameters on a wide variety of display sizes, usually those displays that are smaller than the bedside monitor display. The system and method organizes data in a grid of displayable elements, each displayable element including a piece of information corresponding to a collected physiological parameter of a patient. Depending upon the size of the display, an appropriate number of displayable elements are organized in a grid on the display and the size of each grid on the display is configurable and adjustable by a user.

### FIELD

The present application is directed to the field of patient monitoring. More specifically, the present application is directed to the field of telemetry monitor configuration.

### BACKGROUND

Devices with different screen sizes are used for patient monitoring. As the acuity of a patient changes, they are often monitored with smaller monitors. It is desirable from a user standpoint to maintain a similar user interface across these devices. This is made difficult due to changes in display size and aspect ratio. As these different display sizes are used to display patient data, it is difficult to maintain consistency of the user interface (UI). This introduces confusion in the clinicians when switching between devices, which potentially leads to delays in understanding patient data, or possibly even incorrect interpretation of the data.

According to FIG. 1, a bedside monitor 10 is illustrated including a standard, large-size display of physiological parameters 20 on the monitor 10. In most current systems, this type of bedside monitor 10 is readily utilized to collect physiological parameters 20 from the patient and to display all of the pertinent information on the monitor 10 as shown. FIG. 2 illustrates a typical telemetry monitor 30 currently used to monitor the physiological parameters 20 of a patient on a smaller, handheld-sized device. Typically, in such telemetry monitors 30, only three physiological parameters 20 may be viewed at any given time, and as is shown in FIG. 2, none of the physiological parameters 20 displayed on the telemetry monitor 30 include all of the information shown in the bedside monitor 10 for any one of the physiological parameters 20. In other words, in each of the physiological parameters 20 shown on the telemetry monitor 30, each one is missing a key component. Also, an additional common issue is that current small displays such as telemetry monitors 30 have the capability of only collecting and displaying up to three specific physiological parameters 20, in most cases as shown in FIG. 2. In other words, most current telemetry monitors 30 can collect heart rate, SpO₂, and ECG parameters from a patient and display them as shown in FIG. 2.

### SUMMARY

The system and method of the present application allows for the configurable display of a number of physiological parameters on a wide variety of display sizes, usually those displays that are smaller than the bedside monitor display. The system and method organizes data in a grid of displayable elements, each displayable element including a piece of information corresponding to a collected physiological parameter of a patient. Depending upon the size of the display, an appropriate number of displayable elements are organized in a grid on the display and the size of each grid on the display is configurable and adjustable by a user.

A system for scaling a plurality of displayed physiological data sets comprising, a first monitoring device including a first segmented graphical user interface (GUI), wherein the first segmented GUI includes a plurality of display elements, wherein each of the plurality of display elements is assigned and displays a set of collected physiological data from a patient; and a second monitoring device in communication with the first monitoring device, the second monitoring device including a second segmented GUI, wherein the second segmented GUI has a smaller display area than the first segmented GUI and includes a corresponding display element for each of the plurality of display elements of the first segmented GUI, such that each of the corresponding display elements is assigned and displays the set of collected physiological data corresponding to the first segmented GUI, wherein the size and orientation of each of the corresponding display elements is configurable with a user input.

A method of scaling a plurality of physiological data sets for display comprising, collecting the plurality of physiological data sets from a patient with a data acquisition service; dividing the plurality of physiological data sets into a parameter and control component, an alarm component and a waveform component; checking each of the components with a display resolution assignment for a scaled display; assigning a display element to each of the components; sending the components to a display service; reading the display resolution assignments with the display service; and displaying the components in the assigned display element of the scaled display when the resolution is supported.

A graphical user interface (GUI) for scaling and displaying a plurality of collected physiological data sets, the GUI comprising, a plurality of display elements, wherein each of the plurality of display elements is assigned and displays a set of collected physiological data from a patient, wherein the size and orientation of each of the corresponding display elements is configurable with a user input, wherein the user input includes the user configuring the size of any of the plurality of display elements with a touch screen of the second segmented GUI, and further wherein the size of any of the plurality of display elements is configured by moving any side of the display element or any corner of the display element, and further wherein when the size of any of the plurality of display elements is configured by the user, the size of the remaining plurality of display elements automatically adjusts according to a predetermined algorithm.

### BRIEF DESCRIPTION OF THE FIGURES

FIG. 1 is a graphical representation illustrating an embodiment of a bedside monitor of the present application.

FIG. 2 is a graphical representation illustrating an embodiment of a telemetry monitor of the present application.

FIG. 3 is a schematic block diagram illustrating a segmented graphical user interface (GUI) of a bedside monitor of the present application.

FIG. 4 is a schematic block diagram illustrating a segmented graphical user interface (GUI) of a bedside monitor of the present application.

FIG. 5 is a schematic block diagram illustrating a segmented graphical user interface (GUI) of a telemetry monitor of the present application.

FIG. 6 is a schematic block diagram illustrating a segmented graphical user interface (GUI) of a telemetry monitor of the present application.

FIG. 7 is a schematic block diagram illustrating a segmented graphical user interface (GUI) of a telemetry monitor of the present application.

FIG. 8a is a block diagram illustrating a segmented graphical user interface (GUI) of the present application.

FIG. 8b is a block diagram illustrating a segmented graphical user interface (GUI) of the present application.

FIG. 9 is a flowchart illustrating an embodiment of the method of the present application.

FIG. 10 is a schematic block diagram illustrating an embodiment of a system of the present application.

### DETAILED DESCRIPTION

In one embodiment of the present application, a display is divided into nine grid sections. Each one of the grids has a grid identifier. In one example, the upper right hand corner would be number 3, and the lower right hand corner would be number 9. The grids are then used to display the data that is desired and if the parameter is made larger, the user has the ability to interact with the device to cause the grid to get physically larger. For example, if the user expands the grid to cause it to be larger, the current system takes all the data that the device is capable of displaying and assigns it a number, and then that number equates to a location on the display, assigning a physical place where that data goes every time. If the user wants to enlarge it, they can interact with that point.

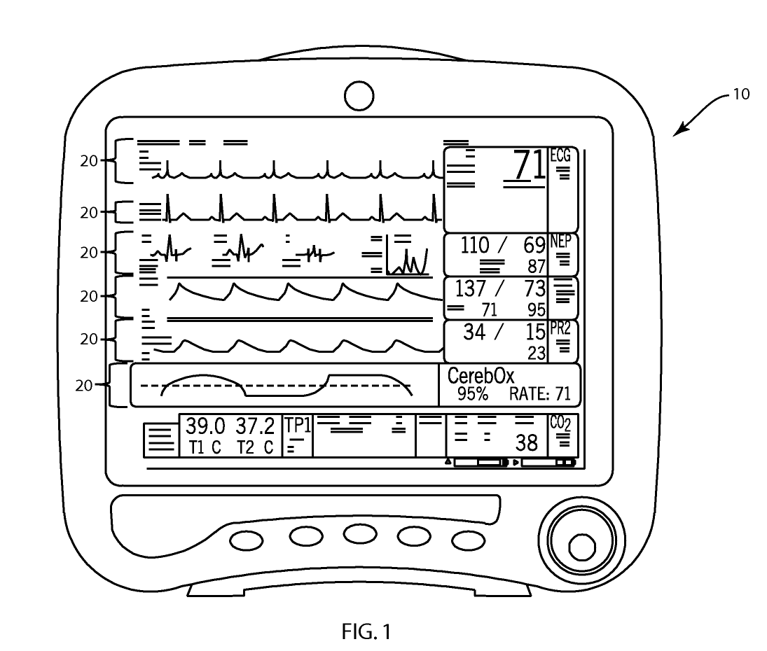

FIG. 1 illustrates a bedside monitor 10, including a display of a number of physiological parameters 20 collected from a patient. These physiological parameters 20 ordinarily include some type of waveform, parameters and control, as well as an alarm condition, as shown. While in the present application, we will refer to this large display as a bedside monitor 10, it should be understood that the bedside monitor 10 is merely illustrative of a larger monitoring device able to clearly and accurately display all portions of the physiological parameters 20 as shown. Other larger displays that have the same function and capabilities, may not be bedside monitors 10, but will include displays with the same capability.

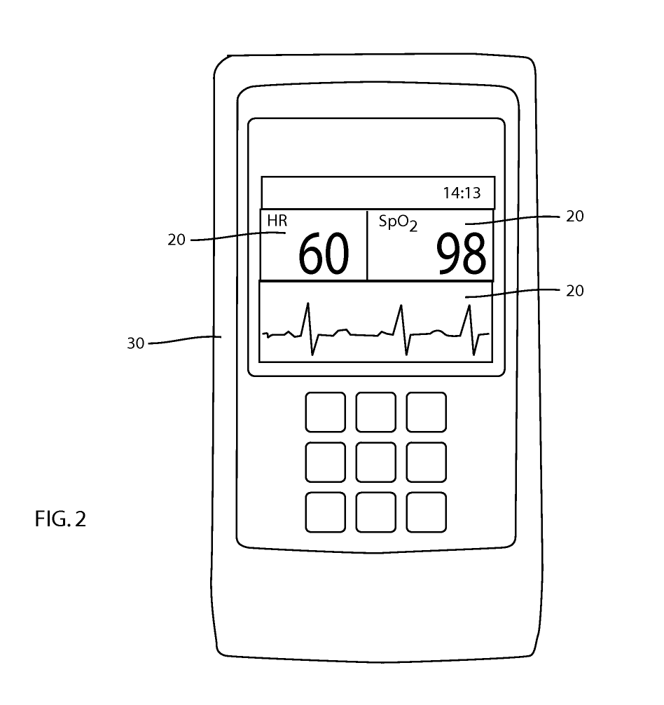

FIG. 2 is illustrative of a telemetry monitor 30 having a smaller display able to display the physiological parameters 20. As discussed above with respect to the bedside monitor 10, the telemetry monitor 30 is intended as illustrative of the limitations of the small display in displaying the physiological parameters 20. In FIG. 2, it is clear that the telemetry monitor 30 is limited in that only portions of the physiological parameters 20 are displayed, and not one of the physiological parameters 20 displayed on the telemetry monitor 30 includes all three of the waveform, parameters and control, and alarm display. Again, the telemetry monitor 30 is illustrative of a device having a small display area, and it should be understood that the system and method of the present application is applicable with other devices having small display areas including, but not limited to, smart phones, PDAs, and small-screened laptops.

Referring still to FIGS. 1 and 2, in one embodiment, the system and method of the present application is effectuated by a set of executable code embodied in software. While not shown, it should be understood that either or both the bedside monitor 10 and telemetry monitor 30 include a storage medium and a processor, wherein the storage medium includes a set of executable code that when executed by the processor, effectuates the operation of the system and method of the present application. It should be further noted that in some systems, a separate device may be utilized having similar components that may execute a set of executable code, thus effectuating the operation of the system and method.

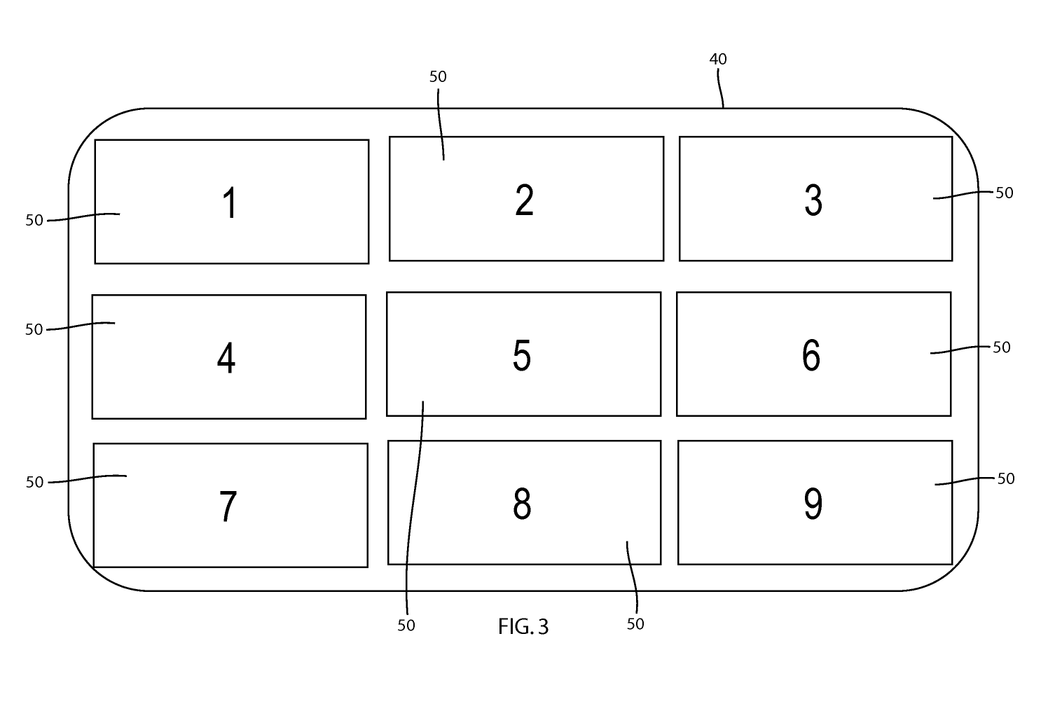

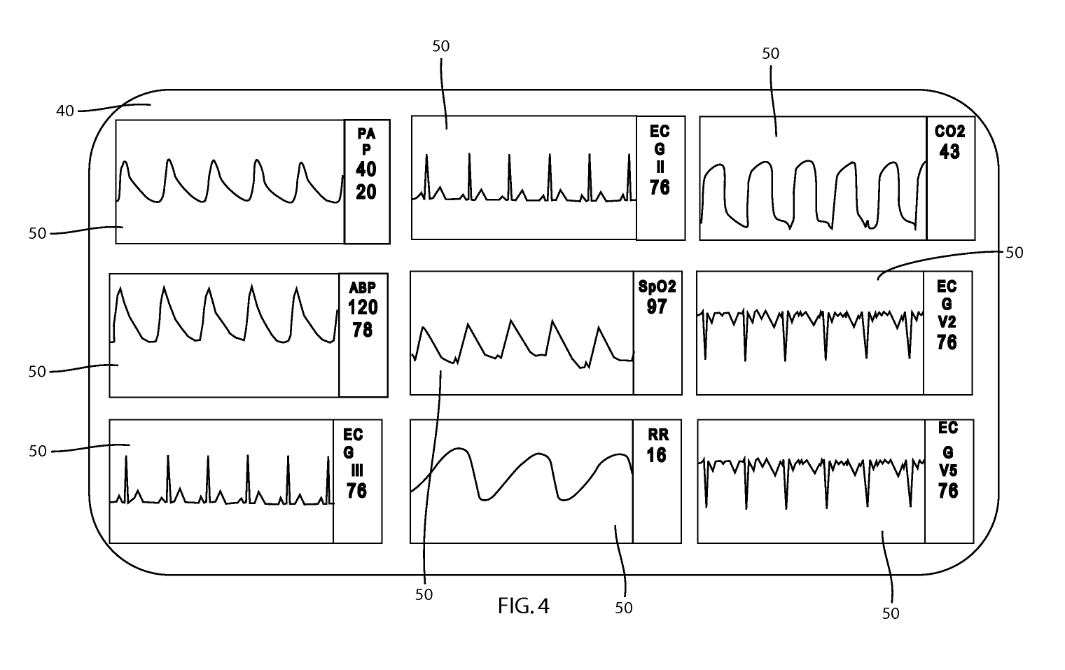

FIG. 3 illustrates a bedside monitor segmented GUI 40 of the present application. Here, the display of the bedside monitor 10 is segmented into a graphical user interface 40 of a grid of display elements 50. Each of the display elements 50 is assigned physiological parameter 20 data, which will be discussed below. Each display element 50 in the grid corresponds to a collected physiological parameter 20 so that when a smaller screen size is utilized for monitoring, each physiological parameter 20 has an assigned spot on the smaller display (in its assigned display element 50). This concept is clearly illustrated in the bedside monitor segmented GUI 40 illustrated in FIG. 4. Here, the display elements 50 are again displayed into a grid format and the physiological parameter 20 data collected from the patient is placed onto its assigned display element 50. It should be noted here that typically bedside monitors 10 are able to display all of the desired physiological parameters 20 that may be collected from a patient, but oftentimes telemetry monitors 30 are limited to a particular few physiological parameters 20. The issues raised by this problem will be discussed in further detail below, but it should be noted in the discussion of FIG. 4 that a user may assign any particular physiological parameter 20 to any particular display element 50, and even change those assignments at a later time if appropriate.

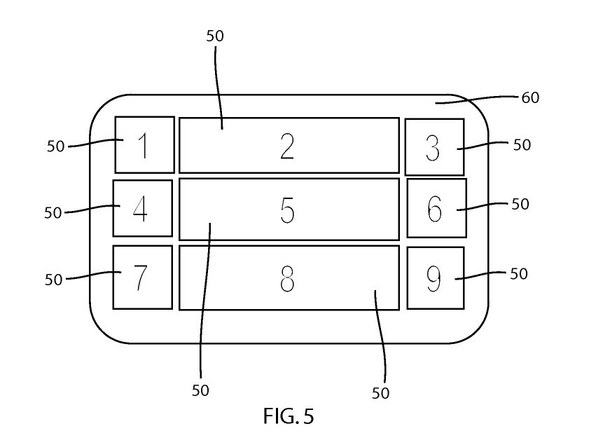

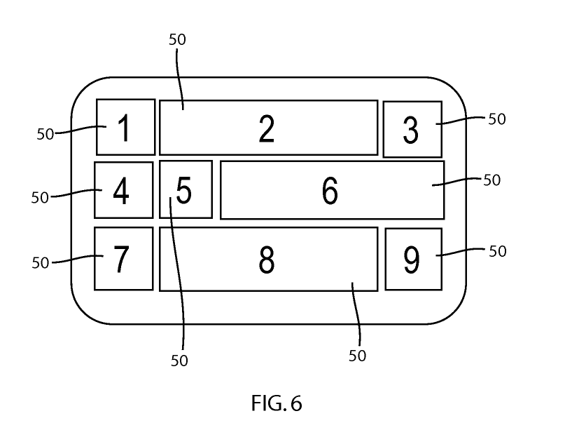

Referring now to FIG. 5, a telemetry monitor segmented GUI 60 of the present application is illustrated. FIG. 5 illustrates one embodiment of this telemetry monitor segmented GUI 60, and it will be shown in later figures that different configurations of the display elements 50 may be implemented in the telemetry monitor 30 display. As shown, the telemetry monitor segmented GUI 60 includes the same number of display elements 50 as that of the bedside monitor segmented GUI 40. However, the telemetry monitor segmented GUI 60 reconfigures the display elements 50 to adapt to the smaller screen size. The GUI 60 in FIG. 5 represents what might be a default arrangement of the display elements 50 of the segmented GUI 60. However, a user once again may set a default setting for the display elements 50 in such a segmented GUI 60 to the user's preferences. For example, the user may set the segmented GUI 60 to have a default setting as illustrated in the display elements 50 as shown in FIG. 6.

In any case, regardless of the default settings of the display elements of the segment 50 of the segmented GUI 60, a user may select any of the display elements using an input device or touch-screen capabilities, and change the size of any one display element. Of course, changing any one of the display elements 50 will affect the size of other display elements 50 in the segmented GUI 60. For example, the configuration of the display elements 50 of the segmented GUI 60 of FIG. 5 to the configuration of the display elements 50 of the segmented GUI 60 of FIG. 6 is the result of the user selecting display element number 6, and making it larger by stretching it to the left side of the GUI 60. In this example, the display element number 5 automatically shortened in length. Of course, there are countless combinations of reconfigurations of the GUI 60 of the user. Furthermore, any of the display elements 50 may be turned off or eliminated from the segmented GUI 60 by the user by switching that particular display element 50 off with a user input and/or through the user enlarging another display element 50 over the display element 50 being eliminated. Referring to FIG. 6 as an example, if a user enlarges display element 6 by moving the left vertical boundary of display element 6 to the left, vertical boundary of display element 5, the display element 5 may be effectively turned off and/or eliminated according to a predetermined algorithm. To effectuate all of this functionality, when a user reconfigures the size of any one of the display elements 50 in the segmented GUI 60, an algorithm including parameters and rules for adjusting the size of the display elements 50 not selected by the user is utilized to reconfigure the display elements 50 in the segmented GUI 60

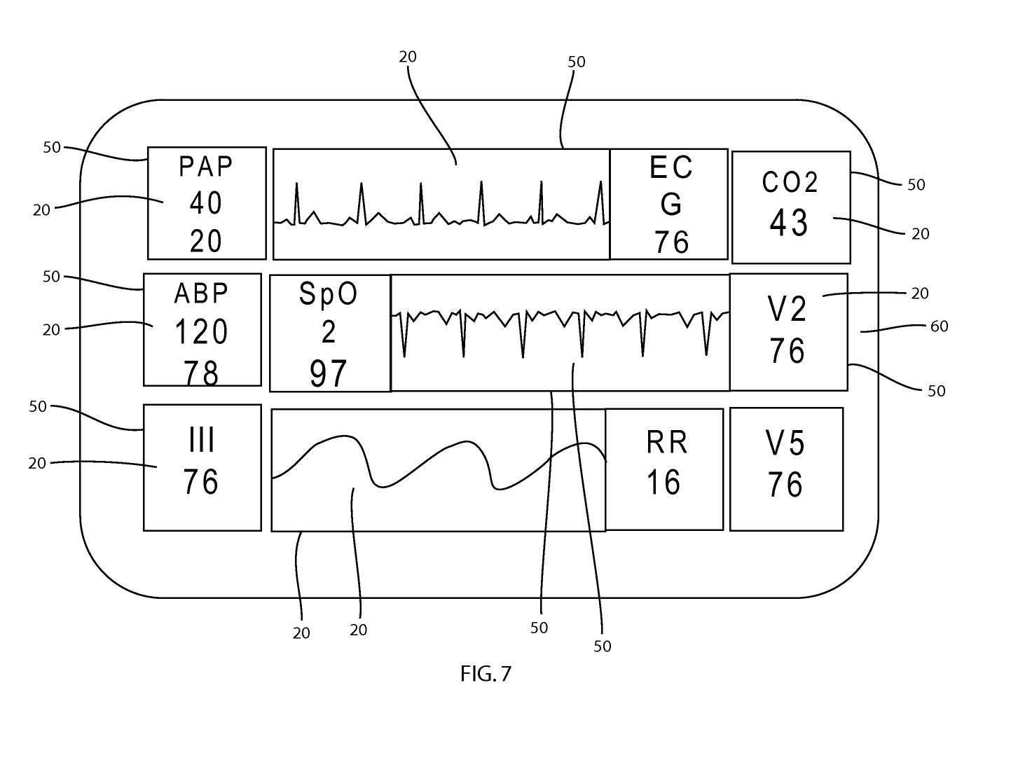

Referring now to FIG. 7, a telemetry monitor segmented GUI 60 of FIG. 6 is depicted, but with the data from the physiological parameters 20 collected from the patient associated with each display element 50. As is shown here, the larger display elements 50, in this case, (display elements 2, 6 and 8), have been stretched as previously shown in FIG. 6. In those display elements 50, the data associated with the physiological parameters 20 collected from the patient are shown in full, meaning that the waveforms, the parameters and control, and the alarms are all shown. Again, once a user selects any one of the display elements 50, that particular display element can be enlarged or shortened according to the user's specification, and the rest of the display elements 50 will adjust according to the algorithm.

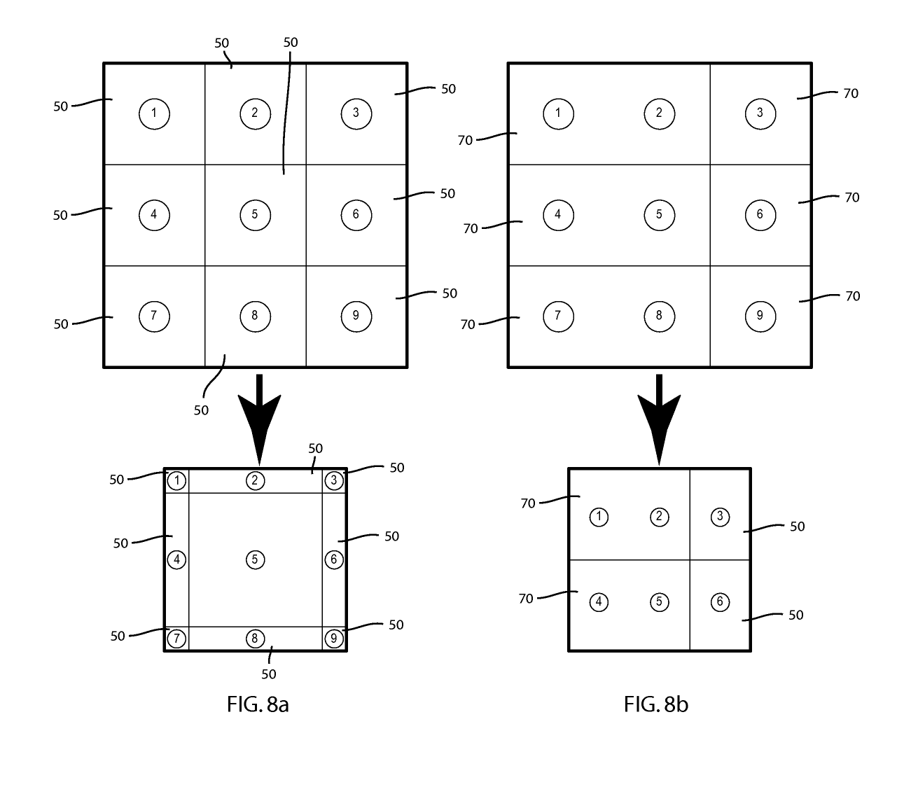

Referring now to FIGS. 8a and 8b, it is illustrated how other embodiments of the system and method of the present application will adjust the display elements 50 when moving from a bedside monitor segmented GUI 40 to a telemetry monitor segmented GUI 60. In FIG. 8a, the bedside monitor segmented GUI 40 includes nine display elements 50 of equal size. However, when the display elements are displayed on the corresponding telemetry monitor segmented GUI 60, display element 5 is given a large percentage of the display, and is centered, with the remaining display elements 50 having varying amounts of space around the perimeter of the segmented GUI 60. Again, FIG. 8a is being provided for illustrative purposes only, and is merely being shown to illustrate that both the bedside monitor segmented GUI 40 and the telemetry monitor segmented GUI 60 may be configured according to user specifications, and altered accordingly.

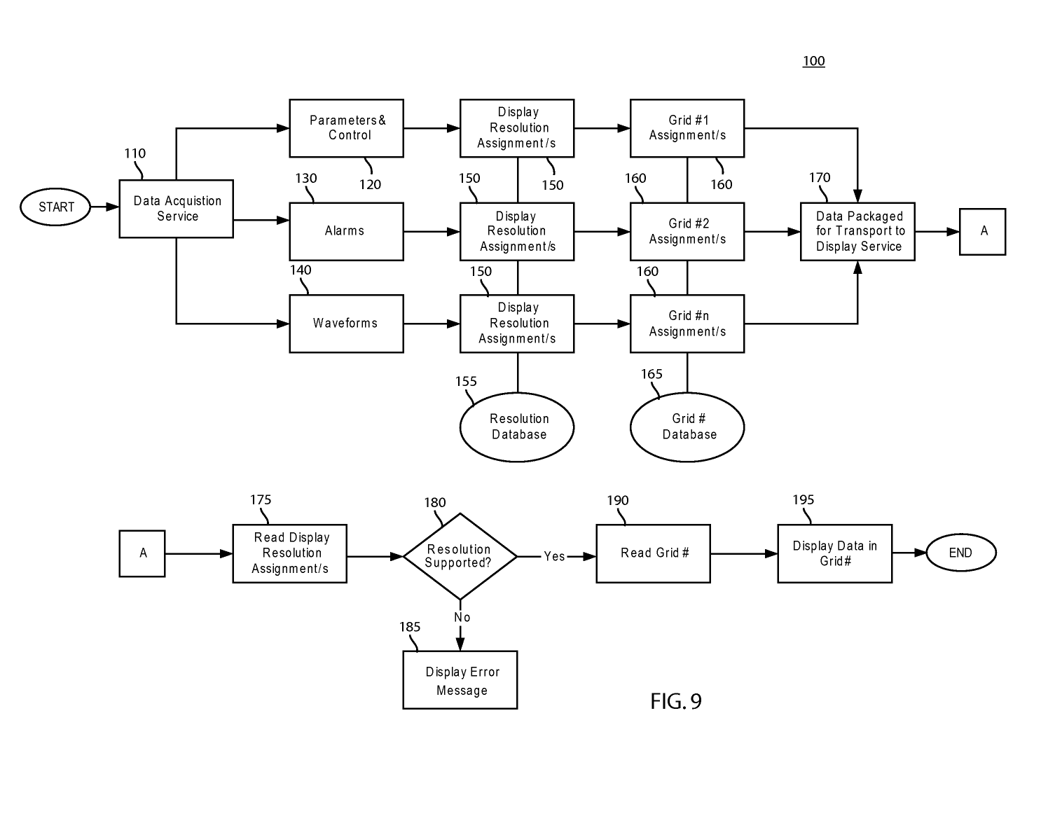

Referring now to FIG. 9, a method 100 of the present application is illustrated in the flowchart. In step 110, a data acquisition service or device collects a set of physiological data for display from a patient. The acquired physiological data is divided into three different display component, including parameters and control 120, alarms 130, and waveforms 140. Each of these categories 120, 130 and 140 are checked against the display resolution assignments 150 for that particular display. The display resolution assignments 150 are stored in a resolution database 155. An example of such checking includes that perhaps for a certain display size, any parameter and control 120 is supported, but that perhaps only certain resolution of waveforms 140 can be supported. Each of the parameters and control 120, alarms 130 and waveforms 140 of the acquired data is then given a grid assignment in step 160 according to a grid number database 165, and in step 170, all of the data is packaged for transport to a display service. Still referring to the method 100 of FIG. 9, in step 175, the display resolution assignments 150 are read, and it is determined in step 180 if the resolution is supported for that particular piece of acquired data. If the resolution is not supported, then an error message is displayed in step 185, and if the resolution is supported, then the grid number is read in step 190, and the data is displayed in that grid number in step 195. This method 100 is utilized for each physiological parameter collected from the patient.

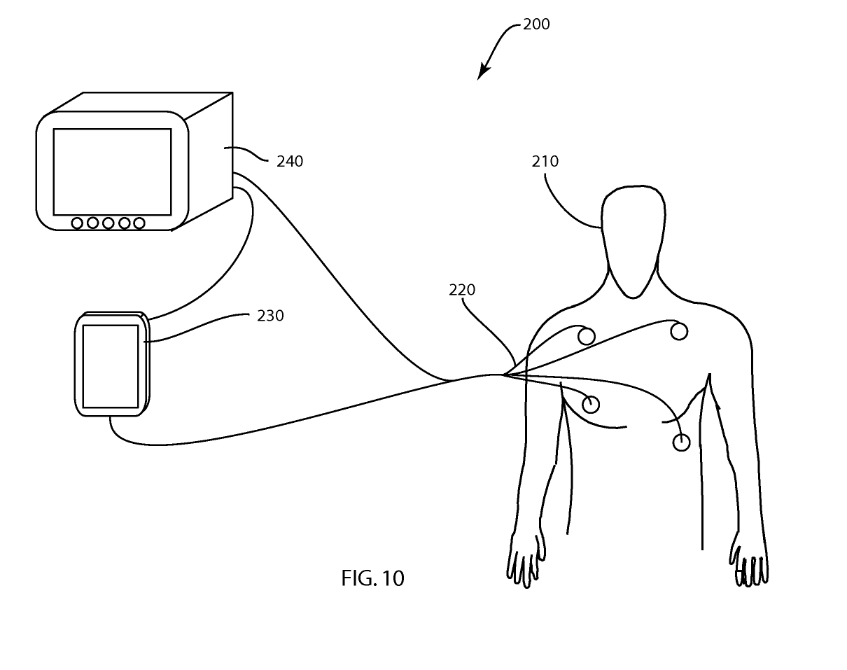

Referring now to FIG. 10, an exemplary monitoring system 200 of the present application is illustrated. Here an acquisition device 220 collects a physiological parameter from a patient 210 and delivers that to either or both of a telemetry monitor 230 and/or bedside monitor 240. Again, as described above, each of the telemetry monitor 230 and bedside monitor 240 is exemplary of a small display device and a large display device, respectively. Furthermore, both the telemetry monitor 230 and the bedside monitor 240 are equipped with a processor and storage medium for executing code in order to effectuate the display system and method of the present application. In one embodiment, the telemetry monitor 230 and the bedside monitor 240 are in communication with one another in either a wired or wireless fashion, in order to transmit or receive portions of the collected physiological data from the patient 210. As was discussed above, some devices such as telemetry monitors 230 are not currently capable of actually collecting more than two or three of the current physiological parameters at one time. Accordingly, in one embodiment of the present application, the bedside monitor 240 is utilized to collect several different physiological parameters from the patient 210, and transfer those signals to the telemetry monitor 230 for display in accordance with the display system and method as outlined above. It should also be noted, that the monitoring system 200 may include additional databases, processing units, storage mediums, or other necessary hardware not specifically pictured in FIG. 10 to effectuate the operation of the system and method of the present application as outlined above.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A system for scaling a plurality of displayed physiological data sets, the system comprising:
a first monitoring device including a first segmented graphical user interface (GUI), wherein the first segmented GUI includes a plurality of display elements, wherein each of the plurality of display elements is assigned and displays a set of collected physiological data from a patient; and
a second monitoring device in communication with the first monitoring device, the second monitoring device including a second segmented GUI, wherein the second segmented GUI has a smaller display area than the first segmented GUI and includes a corresponding display element for each of the plurality of display elements of the first segmented GUI, such that each of the corresponding display elements is assigned and displays the set of collected physiological data corresponding to the first segmented GUI,
wherein the size and orientation of each of the corresponding display elements is configurable with a user input.

2. The system of claim 1, wherein the user input includes a set of instructions entered by a user with an input device for configuring the size of any of the plurality of display elements.

3. The system of claim 1, wherein the user input includes the user configuring the size of any of the plurality of display elements with a touch screen of the second segmented GUI.

4. The system of claim 1, wherein the size of any of the plurality of display elements is configured by moving any side of the display element.

5. The system of claim 1, wherein the size of any of the plurality of display elements is configured by moving any corner of the display element.

6. The system of claim 1, wherein when the size of any of the plurality of display elements is configured by the user, the size of the remaining plurality of display elements automatically adjusts according to a predetermined algorithm.

7. The system of claim 1, wherein the set of collected physiological data is divided into a parameter and control component, an alarm component and a waveform component, and further wherein each of the components are displayed in the corresponding display element when a resolution for each of the components is supported.

8. The system of claim 1, wherein any of the plurality of elements may be turned off or eliminated by a user input.

9. A method of scaling a plurality of physiological data sets for display, the method comprising:
collecting the plurality of physiological data sets from a patient with a data acquisition service;
dividing the plurality of physiological data sets into a parameter and control component, an alarm component and a waveform component;
checking each of the components with a display resolution assignment for a scaled display;
assigning a display element to each of the components;
sending the components to a display service;
reading the display resolution assignments with the display service; and
displaying the components in the assigned display element of the scaled display when the resolution is supported.

10. The method of claim 9, further comprising configuring the size of any of the plurality of display elements with a user input.

11. The method of claim 10, wherein the user input includes a set of instructions entered by a user with an input device.

12. The method of claim 10, wherein the user input includes the user utilizing a touch screen of the scaled display.

13. The method of claim 9, further comprising configuring the size of any of the plurality of display elements by moving any side of the display element.

14. The method of claim 9, further comprising configuring the size of any of the plurality of display elements by moving any corner of the display element.

15. The method of claim 9, wherein when the size of any of the plurality of display elements is configured by the user, the method further includes automatically adjusting the size of the remaining plurality of display elements according to a predetermined algorithm.

16. The method of claim 9, wherein the checking step includes a resolution database including the display resolution assignment for the scaled display.

17. The method of claim 9, wherein a grid number database includes the display elements to be assigned to each of the components.

18. The method of claim 9, further comprising displaying an error message on the display when the resolution is not supported.

19. The method of claim 9, further comprising turning off any of the plurality of display elements with a user input.

20. A graphical user interface (GUI) for scaling and displaying a plurality of collected physiological data sets, the GUI comprising:
a plurality of display elements, wherein each of the plurality of display elements is assigned and displays a set of collected physiological data from a patient, wherein the size and orientation of each of the corresponding display elements is configurable with a user input,
wherein the user input includes the user configuring the size of any of the plurality of display elements with a touch screen of the GUI, and further wherein the size of any of the plurality of display elements is configured by moving any side of the display element or any corner of the display element, and further wherein when the size of any of the plurality of display elements is configured by the user, the size of the remaining plurality of display elements automatically adjusts according to a predetermined algorithm.
